(19) United States
(12) Patent Application Publication
(10) Pub. No.: US 2005/0141423 A1
(43) Pub. Date: Jun. 30, 2005

(54) Method of and apparatus for sorting data flows based on bandwidth and liveliness

(76) Inventors: Jong Kook Lee, Daejeon-city (KR); Jintae Oh, Daejeon-city (KR); Jong Soo Jang, Daejeon-city (KR); Sung Won Sohn, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/004,426

(22) Filed: Dec. 3, 2004

(30) Foreign Application Priority Data
Dec. 24, 2003 (KR) 2003-96892

(51) Int. Cl. H04L 12/26; H04L 12/28

(52) U.S. Cl. 370/232; 370/412

(57) ABSTRACT

A method of and an apparatus for sorting data traffic based on a predetermined priority such as a bandwidth and a liveliness is provided. The method includes operations of: receiving the data flows; sorting the data flows based on bandwidth by defining a plurality of bandwidth ranges and classifying the sorted data flows according to the bandwidth ranges to which the bandwidth of each data flow belongs; and sorting the classified data flows based on liveliness representing frequency of occurrence of the data flows. The sorting of the classified data lows determines that the data flow which is recently received has the higher liveliness and sorts the data flows based on the determination. The method and apparatus facilitates selecting data flows which are possible hostile attack attempts from a vast amount of data traffic and allowing selective and intensive monitoring of the selected data flows.

### BACKGROUND OF THE INVENTION

This application claims the benefit of Korean Patent Application No. 2003-96892, filed on Dec. 24, 2003, in the Korean Intellectual Property Office, the disclosure of which is incorporated herein in its entirety by reference.

1. Field of the Invention

The present invention relates to a network apparatus, and more particularly, to a method of and an apparatus for sorting data traffic based on a predetermined priority such as a bandwidth and a liveliness.

2. Description of the Related Art

The convenience of data communication is maximized as data transmission/reception speed increases thanks to advancing communications techniques. However, communication network abuses such as hacking attempts also advance as the communication network capacity grows bigger. There are many ways hackers use to attack networks. One of them is a so-called flooding attack which increases data traffic in a very short period of time. Consequently, network resources are depleted due to the flooding attack, and main apparatuses on the network are attacked by using this method.

Many countermeasures against various network abuses have also been developed. However, it is not possible to perfectly protect valuable data from hacker attacks which get more and more sophisticated. That is, in some cases, intrusion detectors or security devices under flooding attacks cannot identify the attacks' characteristics, or the detection is not soon enough to root out the attempts. While there is a difficulty in defending against these attacks effectively, the loss by these attacks can result in great economic costs.

To protect against network abuses, an analysis of status or patterns of network data traffic is performed. In addition, many data traffic monitoring solutions such as Cisco NetFlow, nTop, sFlow are used to check the Quality of Service (QoS) of the network or to make billing accounts. However, these solutions have following problems.

First, the conventional solutions do not provide performance high enough to be used in high speed networks. As a result, they detect the status of data traffics by performing packet-samplings while analyzing the data traffic. According to the sampling theorem, detection can be effective and correct only in a given tolerance. Sampling errors can be reduces as the number of samples increases, however, a large number of samples can result in performance degradations.

Second, reporting operations on data traffic status are performed in predetermined intervals. Operation load increases since all information on data traffic status are updated with the same intervals, and the information cannot be provided in real-time. The information on data traffic status can be delivered in nearly real-time as the update periods decrease, however this can result in performance degradations.

As a result, attacks from the outside such as the flooding attack cannot be detected in an early stage since all data traffics cannot be monitored and the information on data traffic status cannot be provided in real-time. Therefore, these detections are not effective in detecting and defending against network attacks. Furthermore, network resources are used ineffectively since data flows are monitored irrespectively of problems of the data flows.

Other conventional measures to detect flooding attacks early include a technique detecting a specific data flow which consumes much bandwidth over the network by using data traffic engineering skills. That is, some computer viruses such as DoS, DDoS, and Worm abruptly generate massive data traffics which have the same specific data field in common. The conventional method can protect networks against outside attacks by using this characteristic.

However, to accomplish early detection of flooding attacks, each data traffic is to be monitored on data flow basis and whether observed packets have the same characteristic in common is to be determined. Much system resources are required in order to monitor all data traffics at the same time. To make it worse, main devices, such as IDS centers or digital commercial servers, require even more resources as the data traffic to be processed increases. However, most apparatuses processing data traffics over high networks have limited resources. Therefore, it is more effective to calculate bandwidths of data flows as soon as the information on the data flow is received, to sort the data flows according to bandwidths of them, and to selectively monitor those flows which consume much bandwidths.

Therefore, contrary to monitoring vast amount data traffics, a method of maximizing the efficiency of network resources by classifying data flows based on common characteristics, sorting the classified data flows according to the bandwidths and liveliness of them, and selectively monitoring controversial data flows is highly required.

### SUMMARY OF THE INVENTION

The present invention provides a method of collecting data flow information from high speed networks such as a backbone network and automatically sorting the data flows according to bandwidths and liveliness (activity) of them.

The present invention also provides an apparatus for selecting data flows which are possible to be hostile attack attempts from the vast amount of data traffic and allowing selective and intensive monitoring of the selected data flows.

According to an aspect of the present invention, there is provided a method of sorting data flows based on bandwidth by separating data traffic transmitted to a terminal through a network into a plurality of data flows having the same destination and sorting the separated flows based on bandwidth and liveliness of the data flows, the method comprising operations of: receiving the data flows; sorting the data flows based on bandwidth by defining a plurality of bandwidth ranges and classifying the sorted data flows according to the bandwidth ranges to which the bandwidth of each data flow belongs; and sorting the classified data flows based on liveliness representing frequency of occurrence of the data flows. And the sorting of the classified data lows determines that the data flow which is recently received has the higher liveliness and sorts the data flows based on the determination. Furthermore, the sorting of the data flows defines the bandwidth ranges to have non-linear relations with respect to one another by considering relativity between upper and lower adjacent bandwidth ranges. It is preferable that the method further comprises operations of: identifying the data flows which are determined to have substantially high bandwidth and liveliness from the data flows which are sorted based on the bandwidth and liveliness of the data flows; and detecting attacks from the outside by monitoring the identified data flows in real time.

According to another aspect of the present invention, there is provided an apparatus for sorting data flows based on bandwidth by separating data traffic transmitted to a terminal through a network into a plurality of data flows having the same destination and sorting the separated flows based on bandwidth and liveliness of the data flows, the apparatus comprising: a receiving module for receiving the data flows; a bandwidth sorting module defining a plurality of bandwidth ranges and classifying the data flows according to the bandwidth ranges to which the bandwidth of each data flow belongs; and a liveliness sorting module sorting the data flows classified into the same bandwidth range based on the liveliness representing frequency of occurrence of the data flows. The liveliness sorting module determines that the data flow which is recently received has the higher liveliness and sorts the data flows based on the determination. The bandwidth sorting module defines the bandwidth ranges so as to have non-linear relations with respect to one another by considering relativity between upper and lower adjacent bandwidth ranges.

It is preferable that the apparatus further comprises: an identifying module identifying the data flows which are determined to have substantially high bandwidth and liveliness from the data flows which are sorted based on the bandwidth and liveliness of the data flows; and an attack detector detecting attacks from the outside by monitoring the identified data flows in real time.

### BRIEF DESCRIPTION OF THE DRAWINGS

The above and other features and advantages of the present invention will become more apparent by describing in detail exemplary embodiments thereof with reference to the attached drawings in which:

FIG. 1 shows a data flow sorting method according to an aspect of the present invention;

FIG. 2 shows in detail a bandwidth calculating operation which uses double-windows in the calculation according to the present invention;

FIG. 3 shows a bandwidth range defining operation according to the present invention;

FIG. 4 shows a data flow sorting operation in the data flow sorting method and apparatus according to the present invention;

FIG. 5 shows a sorting operation of data flows which belong to the same bandwidth ranges based on liveliness; and

FIG. 6 shows an embodiment of the bandwidth range defining operation according to the present invention.

### DETAILED DESCRIPTION OF THE INVENTION

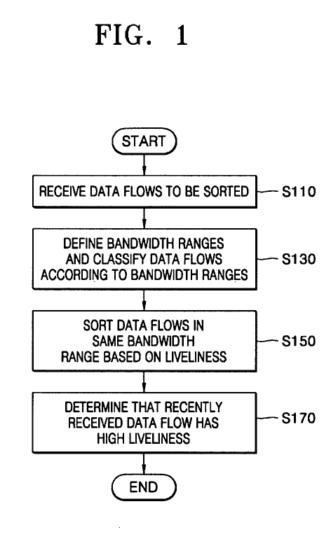

FIG. 1 shows a data flow sorting method according to an aspect of the present invention.

First, data flows to be sorted are received in operation S110 of the data flow sorting method according to an aspect of the present invention. Vast amounts of the received data traffics are separated into data flows based on common characteristics such as the same destinations. Then, the bandwidths of the separated data flows are calculated and the data flows are sorted according to their bandwidths by comparing the calculated bandwidth with those of pre-sorted data flows in operation S130. In S130, all of the received data flows are not sorted sequentially. Rather, a plurality of bandwidth ranges are defined and data flows with bandwidths which belong to a predetermined bandwidth range are just identified to be in the same bandwidth range. Then, the data flows belong to the same bandwidth range are sorted based on the liveliness of them in operation S150. In operation S150, the liveliness of the data flow which is recently received is determined to be the highest among those of the data flows in the bandwidth range in operation S170.

That is, the present invention classifies data traffics over high speed networks into data flows and sorts the classified data flows based on bandwidth and liveliness of them. In this specification, the term ‘liveliness’ means the frequency of occurrence of the received data flows. Therefore, data flows having high frequency of occurrence are determined to have high liveliness, while data flows having low frequency of occurrence are determined to have low liveliness. The present invention can monitor all data traffic over the network and sort the data traffic without packet loss and packet sampling while guaranteeing the line speed of the network. Furthermore, an abrupt change in data traffic patterns can be detected quickly while monitoring the increase/decrease of an arbitrary data flow. In addition, it is possible to protect networks from outside attacks using massive generation of data traffics such as bandwidth attacks and flooding attacks.

By using the sorting method shown In FIG. 1, networks can be monitored while efficiently utilizing limited system resources since data flows are sorted according to their liveliness.

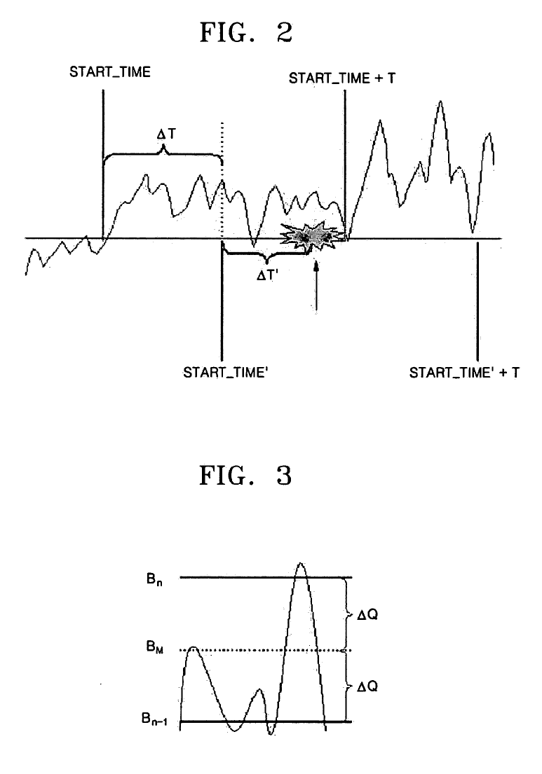

FIG. 2 shows in detail a bandwidth calculating operation which uses double-windows in the calculation according to the present invention.

As shown in FIG. 2, two time windows starting at different start time instants and having same width are used to calculate bandwidths. In FIG. 2, two time windows one of which starts at a first time instant (start_time) while the other starts at a second time instant (start_time′) are shown. The width of both time windows are same as ΔT. A data packet is received from a time instant A which is later than the second time instant (start_time′) by ΔT′. Here, the width ΔT of time windows corresponds to half the value of time difference T between the first time instant (start_time) and the second time instant (start_time′). The first time instant (start_time) and the second time instant (start_time′) are updated at every period T into present time. Suppose that a number of Octets received during ΔT is Prev_Octet while a number of Octets received during ΔT′ is Cur_Octet. Then, bits per second BPS is calculated as in equation (1).

$$\begin{matrix}bps = \frac{Prev\_Octet + Cur\_Octet}{{start\_time}^{′} + Δ {T}^{′} - start\_time} \\ = \frac{Prev Octet + Cur\_Octet}{Δ T + Δ {T}^{′}}\end{matrix} \qquad ( 1 )$$

FIG. 3 shows a bandwidth range defining operation according to the present invention.

In FIG. 3, n-1 and n (n>n-1) are sorting index and Bₙ₋₁ and Bₙ are bandwidths of corresponding index. With respect to a bandwidth B_{M} of an arbitrary data flow, the symbol ΔQ means a range which does not affect the sorting index even while the bandwidth of the data flow increases or decreases from B_{M}. That is, the tolerance ΔQ of B_{M} with respect to Bₙ₋₁ and Bₙ can be given as 0≦Q<0.5. The bandwidth ranges of sorting index can be represented as in equation (2).
Bₙ₋₁=Bₙ*(1-2*ΔQ) (2)

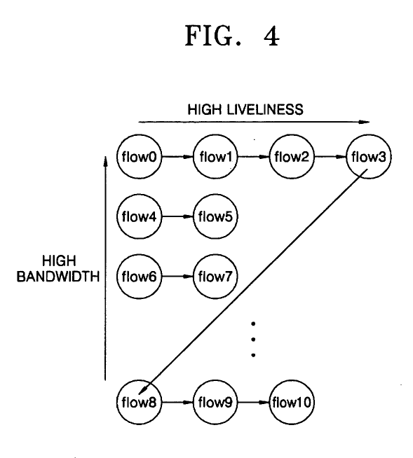

FIG. 4 shows a data flow sorting operation in the data flow sorting method and apparatus according to the present invention.

A bin sorting method in which two criteria are used during sorting operation can be applied in the present invention. That is, each of the bandwidth ranges which is defined by a bandwidth sorting module is denoted as Bin, and those data flows belong to a bandwidth range are sorted based on their liveliness. In FIG. 4, each row denotes bandwidth or Bin, and the rightmost data flows in each Bin has the highest liveliness among those in the bandwidth range. That is, bandwidths of data flows 0, 4, and 6 meet flow6<flow4<flow0 while the liveliness of data flows 0, 1, and 2 meet flow0<flow1<flow2<flow3. Therefore, the data flow having highest bandwidth and liveliness among the data flows shown in FIG. 4 is the third data flow (flow3), and the data flow having lowest bandwidth and liveliness among the data flows shown in FIG. 4 is the eighth data flow (flow8).

As shown in FIG. 4, the only criteria required for the sorting method according to the present invention are bandwidth ranges defined based on data flow bandwidths and liveliness of the data flows to generate a priority queue. Therefore, data flows are easily sorted using the present invention.

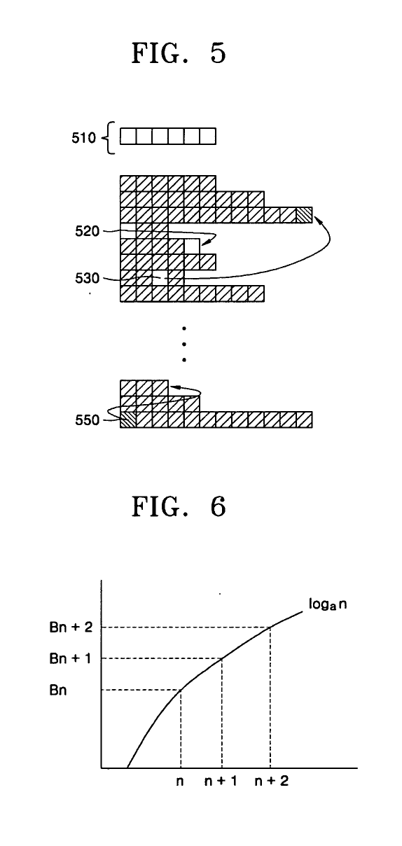

FIG. 5 shows a sorting operation of data flows which belong to the same bandwidth ranges based on liveliness.

That is, FIG. 5 illustrates re-sorting operation of data flows when an arbitrary data flow is received. When an arbitrary data flow is received and the bandwidth of the received data flow corresponds to the upper Bin, the arbitrary data flow is moved to the rightmost position of the upper Bin. When the bandwidth of the arbitrary data flow is not bigger enough for the upper Bin, the arbitrary data flow is moved to the rightmost position of the current Bin.

FIG. 5 shows a plurality of data flows which belong a plurality of bandwidth ranges. The uppermost bandwidth range 510 is shown empty. This means that there is no data flow which corresponds to the highest bandwidth range. Other bandwidth ranges have data flows corresponding to each bandwidth range, respectively. When the bandwidth of a first data flow 520 in the fourth bandwidth range decreases, this data flow 520 is moved to a adjacent lower band range. On the contrary, bandwidths of a second and third data flows 530 and 550 increase and these data flows 530 and 550 are moved to upper bandwidth ranges. As shown in FIG. 5, data flows which are moved to new bandwidth ranges are identified to have the highest liveliness in the new bandwidth ranges.

In doing so, it is assumed that newly-received data flows have high liveliness, and this assumption is quite reasonable considering that the probability of reoccurrence of the newly received data flow is high.

The data flow sorting method according to the present invention can be optimally used for detecting outside attacks. That is, only data flows which are controversial on bandwidths can be separated from the Bin and monitored. Further, among the data flows in the same Bin, only the data flows having high or low liveliness can be separated and monitored against the flooding attacks. That is, the sorting method according to the present invention can identify the data flow due to a suspect outside attacks easily since the method performs sorting based on bandwidths of the data flows. In addition, the sorting method according to the present invention can identify the data flow by intensive monitoring and determine abnormal data flows easily since the method performs sorting based on liveliness of the data flows.

As mentioned above, attack attempts can be detected in an early stage since data flows are managed on bandwidth and liveliness basis. Accordingly the bandwidth of an arbitrary data flow is calculated and updated in real time and the bandwidth variation of the data flow is monitored. As such, It is possible to provide the networks or systems under attack with much time to react against the outside attacks.

The operation of sorting data flows on the liveliness basis is similar to managing a kind of temporary storage region (Cache) for the data flows. That is, the data flows having high liveliness are more probable to be received repeatedly, while the data flows having low liveliness are not active any longer or less probable to be received again. This characteristic is very important considering the performance of networks as well as the efficiency in resource usages. By using the characteristic, data flows with high liveliness can be intensively monitored with data flows with low liveliness eliminated from a monitoring list to manage system resources efficiently and to improve the performance of the network security. In doing so, newly-received data flows can be added to the monitoring list by using an idle system resource which might be occupied by the conventional art. Thus, effective use of system resources is acquired.

FIG. 6 shows an embodiment of the bandwidth range defining operation according to the present invention.

The method for sorting data flows adopts a ‘non-linear bandwidth range magnitudes’ to define bandwidth ranges. For example, a pseudo log scale can be used for defining the bandwidth ranges. The data traffic in high speed networks include a small number of data flows with large bandwidth as well as a large number of data flows with small bandwidth. When the bandwidth ranges are spaced with a constant or a linear spacing, it can be hard to detect a delicate variation of the plurality of data flows with small bandwidth. In addition, a small variation of the few data flows with big bandwidth can result in big data range differences. On the other hand, the data flow sorting method according to the present invention defines the bandwidth ranges to have a relation among them similar to log scales. That is, adjacent bandwidth ranges are to defined to have a similar magnitude ratio. Thus, substantially low bandwidth ranges are spaced with big differences while substantially high bandwidth ranges are spaced with low differences. Therefore, it is possible to detect effectively the small variation in data flows with low bandwidth as well as the big variation in data flows with high bandwidth. FIG. 6 shows the characteristics of the bandwidth ranges according to the present invention. ‘a’, which is a base of logarithm, is a real number larger than 1.

The apparatus for sorting data flows based on bandwidth and liveliness can be implemented in various hardware and software. For example, the apparatus according to another aspect of the present invention can include a receiving module for receiving the data flows, a bandwidth sorting module, and a liveliness sorting module.

The bandwidth sorting module can define a plurality of bandwidth ranges and classify the data flows according to the bandwidth ranges to which the bandwidth of each data flow belongs. The liveliness sorting module can sort the data flows classified into the same bandwidth range based on the liveliness representing frequency of occurrence of the data flows.

In addition, the apparatus according to another aspect of the present invention can be implemented as hardware/software embedded in various devices such as network routers, switches, etc.

Furthermore, the embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

According to the present invention, a method for collecting data flow information from high speed networks such as a backbone network, and automatically sorting the data flows according to bandwidths and liveliness (activity) of them is provided.

According to the present invention, an apparatus for selecting data flows which are possible hostile attack attempts from a vast amount of data traffic and allowing selective and intensive monitoring of the selected data flows is also provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of sorting data flows based on bandwidth by separating data traffic transmitted to a terminal through a network into a plurality of data flows having the same destination and sorting the separated flows based on bandwidth and liveliness of the data flows, the method comprising:
receiving the data flows;
sorting the data flows based on bandwidth by defining a plurality of bandwidth ranges and classifying the sorted data flows according to the bandwidth ranges to which the bandwidth of each data flow belongs; and
sorting the classified data flows based on liveliness representing frequency of occurrence of the data flows.

2. The method of claim 1, wherein the sorting of the classified data lows determines that the data flow which is recently received has the higher liveliness and sorts the data flows based on the determination.

3. The method of claim 1, wherein the sorting of the data flows defines the bandwidth ranges to have non-linear relations with respect to one another by considering relativity between upper and lower adjacent bandwidth ranges.

4. The method of claim 1, further comprising:
identifying the data flows which are determined to have substantially high bandwidth and liveliness from the data flows which are sorted based on the bandwidth and liveliness of the data flows; and
detecting attacks from the outside by monitoring the identified data flows in real time.

5. An apparatus for sorting data flows based on bandwidth by separating data traffic transmitted to a terminal through a network into a plurality of data flows having the same destination and sorting the separated flows based on bandwidth and liveliness of the data flows, the apparatus comprising:
a receiving module for receiving the data flows;
a bandwidth sorting module defining a plurality of bandwidth ranges and classifying the data flows according to the bandwidth ranges to which the bandwidth of each data flow belongs; and
a liveliness sorting module sorting the data flows classified into the same bandwidth range based on the liveliness representing frequency of occurrence of the data flows.

6. The apparatus of claim 5, wherein the liveliness sorting module determines that the data flow which is recently received has the higher liveliness and sorts the data flows based on the determination.

7. The apparatus of claim 5, wherein the bandwidth sorting module defines the bandwidth ranges so as to have non-linear relations with respect to one another by considering relativity between upper and lower adjacent bandwidth ranges.

8. The apparatus of claim 5, further comprising:
an identifying module identifying the data flows which are determined to have substantially high bandwidth and liveliness from the data flows which are sorted based on the bandwidth and liveliness of the data flows; and
an attack detector detecting attacks from the outside by monitoring the identified data flows in real time.
